(19) United States
(12) Patent Application Publication
(10) Pub. No.: US 2008/0004006 A1
(43) Pub. Date: Jan. 3, 2008

(54) Method for notifying network application of client registration in a roaming network

(76) Inventors: Sujay Datta, Aurora, IL (US); Charissa W. Hsu-Chao, Naperville, IL (US); Steven Mark Miller, Batavia, IL (US); Ronald Clare Weddige, Western Springs, IL (US); Chitresh Kumar Yadav, Aurora, IL (US)

Correspondence Address: Lucent Technologies Inc.;Docket Administrator, Room 3J-219, 101 Crawfords Corner Road, Holmdel, NJ, 07733-3030, US

(21) Appl. No.: 11/480,042

(22) Filed: Jun. 30, 2006

(51) Int. Cl. H04Q 7/20

(52) U.S. Cl. 455/432.1

(57) ABSTRACT

The present invention provides a method for notifying a roaming or home network that a client associated with the home network has registered with a roaming network. A client of a home network registers with a roaming network. The roaming network alerts the home network of the registration of the client. The home network sends a message to an application. The message indicates that the client has registered with the roaming network. Messages for the roaming client can now be routed directly to the roaming network without having to first pass through the home network.

### FIELD OF THE INVENTION

The present invention relates generally to mobile communication systems, and more particularly to a method for registering roaming mobile units.

### BACKGROUND OF THE INVENTION

One attractive feature of mobile cellular communication systems is that they allow mobile users of the systems the ability to move. Mobile users may move within their own network, or they may be able to place an receive calls while located in a network distinct from their own. The ability to place and receive calls while located in a non-home network is often referred to as “roaming.” The ability to roam allows mobile users a much greater service area.

A roaming mobile unit is required to register with any network to which it communicates. However, most current communication systems do not pass location information like the IP address or accessing nodes P-CSCF (Proxy-Call Session Control Function) address of a roaming mobile unit to the home or visiting network applications during registration. This leads to delays for the home network or an application in the home network in communicating with the roaming mobile unit, since the home network has to actively search for a roaming mobile unit prior to sending a message to the roaming mobile unit.

Therefore, a need exists for a method of facilitating communication between a home communication network and a mobile unit that is currently roaming.

### BRIEF SUMMARY OF THE INVENTION

The present invention provides a method for notifying a client-registering event to the home network of the mobile unit and to the roaming network. The client, preferably an IMS client, roams to a network that is not its home network. The client registers with this roaming network, typically by sending a registration message. In accordance with an exemplary embodiment of the present invention, the registration message includes the IP address of the client, the address of the P-CSCF of the roaming network, and SIP x-header fields.

The P-CSCF receives information relating to the roaming client. This is preferably accomplished by forwarding the registration information to an I-CSCF (Interrogating-CSCF) within the home network. The registration information can alternately be sent to an IBCF. The I-CSCF or IBCF in the home network looks up the client in a database, such as an HSS. The HSS returns the information about the client's S-CSCF (Service-CSCF) in the home network to the I-CSCF. The I-CSCF then forwards the REGISTER message to the S-CSCF. This is preferably accomplished by sending the information to an S-CSCF of the home network.

Upon receiving an indication that the client is located in the roaming system, an S-CSCF at the home network preferably sends a message to an application. The application can be located within the home network or external to the home network. The message sent to the application preferably includes contact information for the IMS client that has been extracted from the registration message.

The message sent to the application preferably includes an indication that the client has registered with the roaming network and provides an enhanced registration notification to the application. The enhanced notification preferably includes SIP headers, the IP address of the client, and the P-CSCF address of the newly registered client.

The application preferably includes data related to the current location of the roaming client. In an exemplary embodiment, the address of the client is the address of the P-CSCF of the roaming network. The address of the client can also be the IP address of the client or the PDSN Home IP address of the client. The application has the capability to notify other applications that register for notification of incoming client registrations.

The application can notify other applications. This is preferably done by registering the other applications with the application that receives information relating to the current location of a roaming client. Upon receiving updates about a roaming mobile unit, the application then notifies the registered applications to the location of the roaming client. Messages sent to these registered clients may include the IP address of the roaming client, the P-CSCF of the roaming network, or SIP optional x-header fields.

In accordance with an exemplary embodiment, when the client deregisters from the roaming network, the application is notified of the deregistration utilizing the standard IMS protocol. The application then notifies the other applications that registered for updates to the location of roaming mobile units.

An exemplary embodiment of the present invention thereby allows the application to route directly to the client utilizing the IP address of the client or the address of the P-CSCF of the roaming network without having to route the message through the S-CSCF of the home network. This reduces delays for applications in either the home network or the roaming network when communicating with the client, especially while roaming.

### BRIEF DESCRIPTION OF THE SEVERAL VIEWS OF THE DRAWINGS

FIG. 1 depicts an IMS core network in accordance with an exemplary embodiment of the present invention.

FIG. 2 depicts a flowchart of a method for notifying an application of a client registering in a roaming network in accordance with an exemplary embodiment of the present invention.

### DETAILED DESCRIPTION OF THE INVENTION

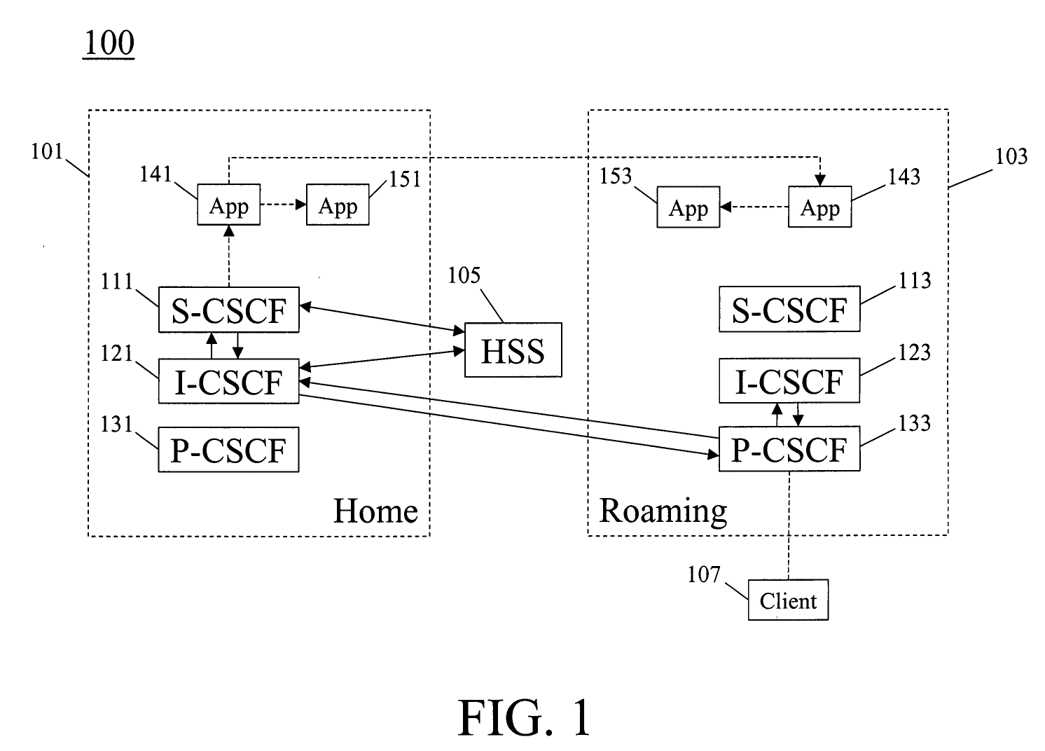

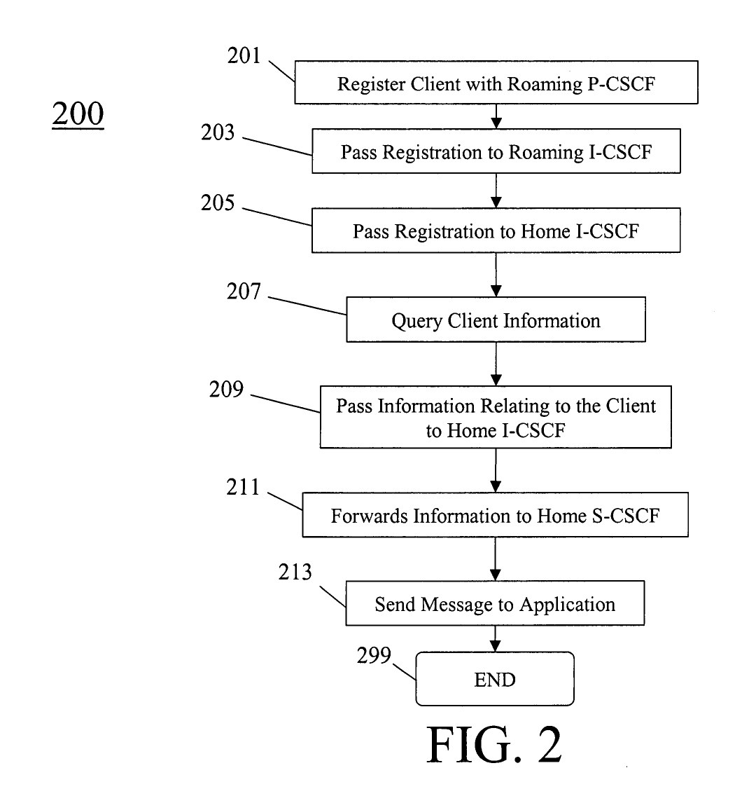

The present invention can be better understood with reference to FIGS. 1 and 2. FIG. 1 depicts an IMS core network 100 that includes a home network 101, a roaming network 103, a Home Subscriber Server (HSS) 105, and a client 107.

Networks 101 and 103 are responsible for call and session control provided by the IMS in a subscriber's home network. Networks 101 and 103 manage SIP sessions, provides features and services, coordinates with other network elements for session control, and allocates media resources.

IMS networks 101 and 103 each include a plurality of functions and components, which may be installed on separate servers or can alternately share the same server. This allows for flexible packaging for various customer needs. IMS network 101 comprises S-CSCF (Serving-CSCF) 111, I-CSCF (Interrogating-CSCF) 121, P-CSCF (Proxy-CSCF) 131, and applications 141 and 151. Roaming IMS network 103 comprises S-CSCF 113, I-CSCF 123, P-CSCF 133, and applications 143 and 153.

S-CSCF 111 manages SIP sessions and coordinates with other network elements for call/session control. S-CSCF 111 performs SIP registration, session control, service control, call monitoring, and security. SIP registration comprises processing SIP REGISTER requests and maintaining subscriber data and state information for the duration of the registration session. Session control comprises performing call/session setup, modification, and termination. Service control comprises interaction with Application Services platforms for the support of features and services. Call monitoring comprises call monitoring and recording for accounting and other related services. Security comprises providing security for the session.

SIP user clients communicate to the various application servers via S-CSCF 111. S-CSCF 107 provides the messaging filtering, message forwarding, and transaction and session control functions for the sessions initiated by SIP signaling. S-CSCF 111 also allows the various SIP-based application servers to communicate with each other. S-CSCF 111 also preferably provides SIP proxy functions for forwarding SIP messages to the proper application server and allowing application servers to subscribe to SIP dialogs between SIP clients and servers.

Because S-CSCF 111 supports standard SIP messages, the user clients and SIP application servers can span a wide variety of telephony and non-telephony services. For example, S-CSCF 111 can provide the message filtering and forwarding for SIP-based services such as Instant Messaging (IM), Push-To-Talk, and multimedia services.

I-CSCF 121 is the contact point within network 101 for all connections destined to a subscriber connected to network 101 or a roaming subscriber currently located within the service areas supported by network 101. Network 101 may include multiple I-CSCFs. I-CSCF 121 assigns an S-CSCF to a user performing SIP registration. I-CSCF 121 also obtains from HSS 105 the address of S-CSCF 111 and uses the address to route a SIP request or response received from a network towards S-CSCF 111.

P-CSCF 131 is preferably the first contact for a SIP mobile unit to gain access to network 101 from the access packet network domain. P-CSCF 131 provides the necessary SIP routing capability between SIP mobiles and network 101. P-CSCF 131 also coordinates with the access network to authorize the resources and Quality-of-Service (QoS). For services that are offered by the home IMS network, P-CSCF 131 relays the SIP signaling to the IMS server in the home network.

HSS 105 is the master subscriber database for system 100 and includes registration status and subscription data for users. The data within HSS 105 is used by the different network core functional entities in IMS 100 when processing subscribers. HSS 105 includes user data that can be downloaded to S-CSCF 111 and S-CSCF 113. HSS 105 stores temporary data with the location of S-CSCF 111 where the user is currently registered.

Client 107 is a subscriber device that is preferably capable of placing and receiving calls within system 100, either by utilizing home network 101 or, when roaming, by utilizing roaming network 103.

Elements in roaming network 103 perform similar functions to similarly-names elements in home network 101.

FIG. 2 depicts a flowchart 200 of a method for notifying a home network of a client registering in a roaming network in accordance with an exemplary embodiment of the present invention.

In accordance with an exemplary embodiment, IMS client 107 has home network 101 as its home network. IMS client 107 registers (201) with roaming P-CSCF 133 by sending a registration message. In a typical network, P-CSCF 133 is unaware of the home system of IMS client 107. In an exemplary embodiment, the registration message includes the IP address of client 107, the address of P-CSCF 133, and optional SIP x-header fields.

P-CSCF 133 passes (203) registration information to I-CSCF 123. P-CSCF also passes (205) registration information to I-CSCF 121. I-CSCF 121 looks up (207) client 107, preferably utilizing Diameter, in HSS 105.

HSS 105 passes (209) the information relating to client 107 to I-CSCF 121. The information includes the address of S-CSCF 111. I-CSCF 121 forwards (211) registration information to S-CSCF 111.

Upon receiving an indication that client 107 is located in roaming system 103, S-CSCF 111 preferably sends (213) a message to application 141. S-CSCF 111 preferably extracts the contact information of IMS client 107 from the registration message. In an exemplary embodiment, this information replaces the address of S-CSCF 111. In an exemplary embodiment, S-CSCF 111 can send the message to multiple applications.

The message includes an indication that client 107 has registered with roaming network 103. The message preferably provides an enhanced application notification to application 141. The enhanced application notification preferably includes SIP headers, the IP address of client 107, and P-CSCF 133 of the newly registered network.

Application 141 includes data related to the current location of roaming client 107. In an exemplary embodiment, the address of client 107 is the address of P-CSCF 133. In a further exemplary embodiment, the address of client 107 is the IP address of client 107. In a further exemplary embodiment, the address of client 107 is the PDSN Home IP address of client 107.

Additionally, application 141 has capability to notify other applications that register for notification of incoming client registrations. Application 141 preferably determines if client 107 is roaming by checking either the incoming IP address of the client or domain of the P-CSCF.

Application 141 in home network 101 can notify other applications in home network 101. In accordance with an exemplary embodiment, other applications at home network 101 register with application 101 if they want to be updated with the registration status of roaming clients. Messages sent to other applications can include the IP address of the roaming client, the P-CSCF of the roaming network, or SIP xhdr fields. This allows application 141 to route directly to client 107 utilizing the IP address of client 107 or the address of P-CSCF 133 without passing through the S-CSCF 111. This reduces delays for applications in either home network 101 or roaming network 103 when communicating with the client 107.

In accordance with an exemplary embodiment, when client 107 deregisters from network 103 application 141 is notified of the deregistration utilizing the standard IMS protocol. Application 141 then preferably notifies other applications, such as application 151, application 153, and application 143.

While this invention has been described in terms of certain examples thereof, it is not intended that it be limited to the above description, but rather only to the extent set forth in the claims that follow.

We claim:

1. A method for notifying a home application and a roaming application that a client associated with a home network has registered with a roaming network, the method comprising:
registering by a client with a roaming network;
sending a first registration message to a home application, the first registration message indicating that the client has registered with the roaming network; and
sending a second registration message to a roaming application, the second registration message indicating that the client has registered with the roaming network.

2. A method for notifying a home application and a roaming application that a client associated with a home network has registered with a roaming network in accordance with claim 1, wherein the first registration message includes an Internet Protocol (IP) address of the client.

3. A method for notifying a home application and a roaming application that a client associated with a home network has registered with a roaming network in accordance with claim 1, wherein the first registration message includes an address of a P-CSCF (Proxy Call Session Control Function) of the roaming network.

4. A method for notifying a home application and a roaming application that a client associated with a home network has registered with a roaming network in accordance with claim 1, wherein the first registration message includes at least one SIP (Session Initiation Protocol) x-header field.

5. A method for notifying a home application and a roaming application that a client associated with a home network has registered with a roaming network in accordance with claim 1, the method further comprising the step of storing information from the first registration message in the home application.

6. A method for notifying a home application and a roaming application that a client associated with a home network has registered with a roaming network in accordance with claim 1, wherein the step of registering by a client with a roaming network comprises sending a roaming message, and wherein the step of sending a first registration message to a home application comprises sending a message that includes information extracted from the roaming message.

7. A method for notifying a home application and a roaming application that a client associated with a home network has registered with a roaming network in accordance with claim 1, wherein the step of sending a first registration message to a home application comprises sending a message that includes a SIP (Session Initiation Protocol) header.

8. A method for notifying a home application and a roaming application that a client associated with a home network has registered with a roaming network in accordance with claim 1, wherein the step of sending a first registration message to a home application comprises sending a message that includes the IP address of the client.

9. A method for notifying a home application and a roaming application that a client associated with a home network has registered with a roaming network in accordance with claim 1, wherein the step of sending a first registration message to a home application comprises sending a message that includes an address of the P-CSCF (Proxy Call Session Control Function) of the roaming network.

10. A method for notifying a home application and a roaming application that a client associated with a home network has registered with a roaming network in accordance with claim 1, further comprising the step of storing a current location for the client at the home application.

11. A method for notifying a home application and a roaming application that a client associated with a home network has registered with a roaming network in accordance with claim 10, wherein the current location for the client comprises the address of the P-CSCF from the roaming network.

12. A method for notifying a home application and a roaming application that a client associated with a home network has registered with a roaming network in accordance with claim 10, wherein the current location for the client comprises the IP address of the client.

13. A method for notifying a home application and a roaming application that a client associated with a home network has registered with a roaming network in accordance with claim 10, wherein the current location for the client comprises the PDSN Home IP address of the client.

14. A method for notifying a home application and a roaming application that a client associated with a home network has registered with a roaming network in accordance with claim 10, wherein the current location for the client comprises a SIP x-header field.

15. A method for notifying a home application and a roaming application that a client associated with a home network has registered with a roaming network in accordance with claim 1, further comprising the step of notifying other applications that the client is roaming.

16. A method for notifying a home application and a roaming application that a client associated with a home network has registered with a roaming network in accordance with claim 15, wherein the step of notifying other applications that the client is roaming comprises notifying other applications that register for notification service.

17. A method for routing a message directly to a roaming client comprising:
registering by a client with a roaming network;
sending a registration message to a home application located at a home network of the client, the registration message indicating that the client has registered with the roaming network;
storing the registration message at the home application;
receiving a request for the client at the home network;
determining the location of the client by retrieving the registration message from the home application; and
routing a message directly to the client using the information retrieved from the home application.

18. A method for routing a message directly to a roaming client in accordance with claim 17, wherein the step of routing a message directly to the client comprises routing a message directly to the client utilizing the IP address of the client.

19. A method for routing a message directly to a roaming client in accordance with claim 17, wherein the step of routing a message directly to the client comprises routing a message directly to the client utilizing the P-CSCF of the roaming network.
